(19) United States
(12) Patent Application Publication
(10) Pub. No.: US 2005/0216226 A1
(43) Pub. Date: Sep. 29, 2005

(54) Method for determining physical properties of wood

(76) Inventors: Michael J. Yancey, Puyallup, WA (US); Tom J. Taylor, Seattle, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 10/607,859

(22) Filed: Jun. 26, 2003

(51) Int. Cl. G06F 15/00

(52) U.S. Cl. 702/171

(57) ABSTRACT

Stiffness and other properties of a wood member, such as a log, can be determined by excitation with a swept frequency sonic pulse followed by measurement of the resonant frequency by an accelerometer in contact with the log. It is desirable to minimize the sweep range in order to utilize the power in the sonic pulse to the maximum effect. This should be centered about the expected resonant frequency and is typically no more than about 300 HZ either side of the expected frequency. The resonant frequency is dependent principally on wood species and length. By first measuring length and inputting this into the associated software the sweep range can be controlled to achieve the maximum output signal. Time duration of the sweep is typically no longer than about 0.2 seconds and can be considerably shorter.

The present invention relates to a nondestructive method for determining at least one physical property of a wood member. It further relates to a method of optimizing value of the member during further processing.

### BACKGROUND OF THE INVENTION

It has been long known to use nondestructive testing methods for determining some physical property of a wood member which relates to its strength or soundness. Items such as logs, utility poles, or lumber intended for engineering applications are routinely tested. One means of doing this is to induce a stress wave within the material and note a response characteristics; e.g., the time of travel of the wave, to infer the property being studied. The stress wave may be induced by striking the material with a hammer and noting the response by means of an accelerometer in contact with the piece. Another way is to direct a sonic pulse at the material, either by a transducer in direct contact, or by an external transducer through an air gap. The sonic pulse may be swept through a range of frequencies since the impedance of the wood is high to any but frequencies at or very near the resonance point, or to harmonics of this frequency. Said differently, a stress wave is not created within the test piece if the exciting frequency range does not include a frequency at about the fundamental resonance frequency of the piece being tested. For this reason, the sweep ranges used in the past tend to be very wide and the pulse time to deliver them relatively long.

A number of earlier investigators have looked at varying means of using sonic pulses to determine physical properties of wood members. Exemplary methods found in the patent literature include British Patent Application GB 2 077 431; published PCT Application WO 02/08747 to Harris; and U.S. Pat. Nos. 5,621,172 to Wilson et al, and 5,824,908 to Shindel et al. Systems using mechanically induced shock waves that measure end-to-end transit time of the wave in the sample have been in use for evaluating logs and assigning them for optimum use based on the determined elastic modulus. Such a system is described in Snyder et al, U.S. Pat. No. 6,026,689. The system is normally employed on a log ladder in a sawmill or merchandiser where the logs must be even ended for access to the pneumatic hammer. It is also necessary for the log to remain stationary for the short time required for the test. The need for the logs to be even ended poses some difficulty since the heavy logs, which are frequently of varying lengths, must be brute force adjusted into the proper position.

All of the systems noted above suffer some deficiency when used in an industrial environment such as a sawmill or log sort yard. These environments have inherently high background noise. This greatly complicates the use of noncontact systems and makes detection of the weak stress wave induced in the log extremely difficult to separate from the noise. Even-ending of the logs poses a considerable and sometimes insolvable problem. Further, the logs are often moving at a high rate of speed and the time window in which a reading may be made is frequently considerably less than a second. The present invention is an improvement in the known systems and successfully overcomes the problems just noted.

### SUMMARY OF THE INVENTION

The present invention is a non-contact method for determination of one or more physical properties in a wood member such as a log or structural timber. When the term “log” is used, it is a term of convenience and should be read with sufficient breadth to include any elongated wood member being tested for structural properties.

The method employs a swept audio frequency pulse directed at one end of the member. The time of travel of the sonic pulse to the log end and back is measured by an accelerometer in contact with the log. Alternatively, a non-contact transducer such as a laser Doppler vibrometer may be used to receive the returned signal. The returned signal is converted into the frequency domain and the resonant frequency of the log is determined. In prior methods using a non-contact swept frequency, a wide sweep range is employed to ensure that not only the resonant frequency of the test material is included but a considerable number of harmonics as well. This has the disadvantage that the power of the sonic pulse is distributed over a very wide range while only a very small part of the signal is useful to excite a response in the log. The log has high impedance to frequencies other than the fundamental or its harmonics. The result is that the returned signal is normally very weak and difficult to pick out of the ambient noise. In many industrial environments the ambient noise transmitted into a sample being tested is very high. Typically, it is also at the lower frequencies. One might assume that the power of the input audio pulse could simply be increased to overcome this problem. This is generally not practical, both from the equipment and environmental standpoints. The transmitted sonic burst then becomes extremely loud. At best it would be a major annoyance and at worst a serious health hazard inflicting permanent hearing damage.

The present invention solves the above problems by using only a relatively narrow and very short frequency sweep which concentrates its power in the most useful range. Sweep range will be determined by the species of wood being measured and by its length. A given species of wood of a given length will have a resonant frequency within a range that is known or can be readily determined by standard sampling techniques. The resonant frequency is fixed predominantly by length and density of the specimens. Some density variation is normal. In turn, density affects the elastic modulus (stiffness), the principal property being measured. By limiting an applied swept audio pulse to the relatively narrow frequency range that is centered approximately at the center point of the known resonant frequency range of the material being tested, a much higher percentage of the applied energy is accepted by the sample. This enables use of a relatively lower energy initial pulse and, in turn, gives a much stronger response pulse relative to the ambient noise.

The advantages of the present method are manifold. It is no longer necessary to even-end the logs as is needed with a mechanical impacter. By limiting the applied frequency sweep to only the range which will be effective, not only is the applied power used much more efficiently but the pulse time can be significantly shortened. This is a major advantage when the product being tested is moving at a rapid speed and is only momentarily available for the test. Audio pulse durations can fall within the range of 0.001 to 1.0 seconds but preferably are no longer than about 0.2 seconds and more preferably about 0.1 second or less. A sweep time in the range of about 0.005 to 0.2 seconds is most preferred. By first inputting the length of the member being tested, the frequency range of the sound pulse can accordingly be adjusted by the simple associated software. For typical sawmill logs the sweep range is typically no more than about ±300 Hz either side of the expected centerline of the sample resonant frequency range. As an example, for a 10 ft (˜3.0 m) southern pine log a sweep range may be only about ±250 HZ either side of a resonance range center point of about 560 HZ. For a 20 ft (˜6.1 m) log the resonance range center point is about 280 Hz. For these lower resonant frequencies the expected range of variation will be narrower and the sweep range can be reduced accordingly. The sweep range should be sufficiently wide as to encompass the expected range of variation about an average centerpoint. This range can be readily determined for logs of a given length and species by standard sampling techniques. While there is no harm in using wider sweep ranges, it does result in a reduced amount of the available sound pulse power being transferred into the log. It is not essential to use the higher frequencies that fall into the range of harmonics of the fundamental

The speed of the stress wave transmitted into the log can be readily determined by the equation S=2Lf, where L is the length of the log and f is the resonant frequency. Stress wave speed is known to relate directly to modulus of elasticity (MOE), with lower speeds indicating a lower MOE. Knowledge of the MOE can then be used to determine subsequent use of the log. Low modulus logs can be sawn into dimension lumber sizes or grades where strength is not critical or can even be directed for production of pulp chips or composite panels. U.S. Pat. No. 6,026,689 is descriptive of how knowledge of MOE can be used to maximize product value of saw logs.

It is an object of the present invention to provide an improved non-contact method for evaluation of at least one physical property of a wood member.

It is a further object to provide a method using a sound pulse to excite resonance within such a member, the sound pulse being swept in frequency over a relatively narrow range generally centered about the expected resonant frequency range of the member.

It is another object to provide a method for non-destructive evaluation of a wood member using swept frequency sound pulses no longer than about 0.2 seconds duration.

It is also an object of the invention to first determine length of the member in order to adjust the sweep range of the sound pulse.

These and many other objects will become readily apparent upon reading the following detailed description taken in conjunction with the drawings.

### BRIEF DESCRIPTION OF THE DRAWINGS

FIG. 1 is a block diagram showing essential elements required for the present method.

FIG. 2 indicates the 0.20 second duration swept frequency signal used to excite the log being measured.

FIG. 3 indicates the analog voltage response of the transducer measuring the ringdown response of the log.

FIG. 4. shows the voltage response of FIG. 3 converted from the time to the frequency domain.

FIGS. 5-7 are similar to FIGS. 2-4 except the swept frequency time duration is 0.01 seconds.

FIGS. 8-10 are similar to FIGS. 2-4 except the swept frequency time duration is 0.005 seconds.

### DETAILED DESCRIPTION OF THE PREFERRED EMBODIMENTS

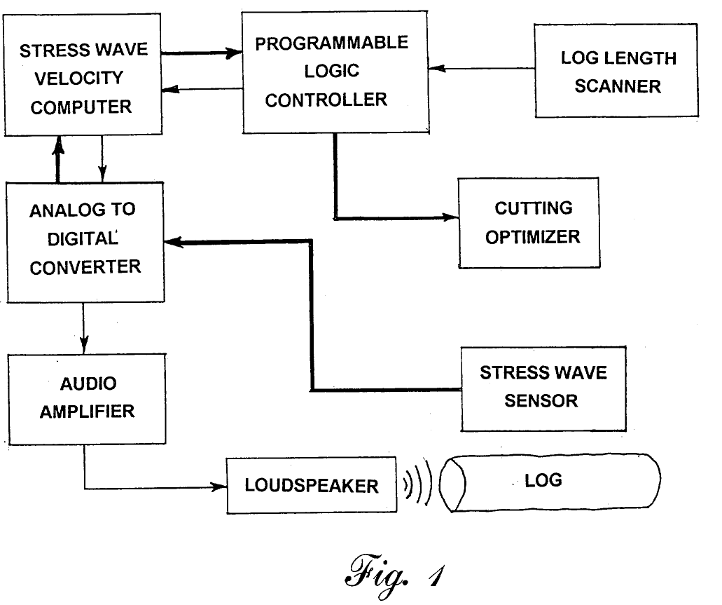

Referring now to FIG. 1, operation of the method will be explained in detail. While this example describes a sawmill environment, this in no way is intended to be limiting since the applicability of the method in many different uses is evident. As an example, it may be assumed that the necessary apparatus is installed in conjunction with a log ladder where logs to be sawn are fed into the sawmill from an outside source. The log ladder is a conveyor in which logs are carried side-by-side in parallel fashion. At some point the log length will be measured, most usually by a laser scanner. The length information for each individual log is fed as one input to a programmable logic controller. The programmable logic controller as output sends the log length to the stress wave velocity computer, controls the movement of the log ladder, and calls for the audio pulse to be directed toward the end of the log. The log ladder may be momentarily stopped by the programmable logic controller while the measurements are being made.

A stress wave velocity computer, which may be an off-the-shelf personal computer, receives the log length from the programmable logic controller, uses it to set the frequency sweep range, and directs the audio amplifier to initiate the sound pulse. The sound pulse is directed at one end of the log by a transducer. This may be a conventional loudspeaker sufficiently shielded to protect it in the use environment. At the time of the sonic pulse a stress wave sensor is alerted to receive the response stress wave. One suitable type of response transducer may be one or more accelerometers in contact with the log. These may be mounted on a swinging arm which is also activated by the programmable logic controller. The arm will appropriately move in and out of contact with the log. Alternatively, a non-contact transducer such as a laser Doppler vibrometer may be used to receive the stress wave. A suitable device of this type is a Model PDV 100 available from, Polytec, Waldbrom, Germany. The route of response signals are indicated on FIG. 1 by a heavier line. The received signal is fed to an analog to digital converter where it converted from the time domain into the frequency domain This information, in turn, is sent to the stress wave velocity computer where the stress wave velocity is calculated. Since stress wave velocity is related to stiffness this value may alternatively be converted to modulus of elasticity. In turn the stress wave velocity or stiffness value is sent back to the mill programmable logic controller. From there it may be used in a cutting optimizer program which determines how the log should be sawn or otherwise utilized for maximum product value. U.S. Pat. No. 6,026,689 describes such a program.

It is known that the resonant frequency is primarily affected by log length and density, the density typically being closely related to species. Diameter is a minor factor that can usually be neglected. Moisture content will affect density somewhat.

### EXAMPLE 1

A green Douglas-fir log having a length of 11.6 ft (˜3.5 m), a major end diameter of 14 in (0.35 m) and a minor end diameter of 12 in (0.30 m) was used for the following laboratory tests. Experience has shown that the average resonant frequency for a log of this species and length would be expected to fall within the range of about 350-650 Hz. Referring to FIG. 1, log length data were input manually and the log was not intended to be sawn. The stress wave velocity computer was an off-the shelf personal computer. The analog to digital converter (A/D) card used in the computer was supplied by National Instruments, Austin, Texas. The audio amplifier was a Model World 2.1 Stewart Audio Amplifier supplied by Stewart Electronics, Columbia, Calif. The loudspeaker was a standard Pro Power 15 inch JBL W15GTi subwoofer purchased from an audio supply store. The stress wave sensor was a Model 8702B50 accelerometer supplied by Kistler Instruments Corp, Amherst, N.Y. It will be understood that this is not an intended as an endorsement of these particular products since fully equivalent devices are available from a number of suppliers.

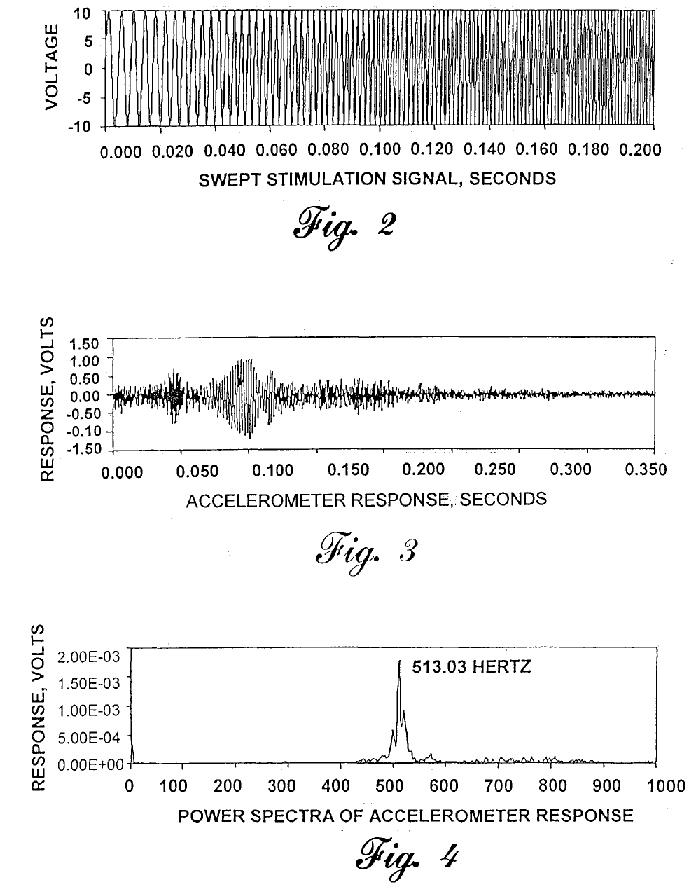

As seen in FIGS. 2-4, the results show the response of a log to a short duration swept sine wave audio input. The log was stimulated with a 0.2 second duration signal with a start frequency of 200 Hz and an end frequency of 1000 Hz.

The swept sine output signal was generated in the computer software and output using the D/A converter on a data acquisition card. Update rate for the output signal was 44.1 kHz. The output signal was used as the input signal of the amplifier which drove a subwoofer speaker aimed at one end of the log and approximately 3 ft away.

The response was measured with the accelerometer bearing against the opposite end of the log. The accelerometer signal was acquired with an input channel on the data acquisition card. Sample rate for the input signal was 10 kHz. Data were recorded for 0.5 seconds to capture the ringdown response as well as the forced response.

The acquired signal was analyzed using a power spectra analysis. The peak frequency identified represents the standing wave frequency of the log. Together with the log length, this parameter can be used to calculate the speed of sound in the log which is known to relate to the modulus and stiffness.

FIGS. 2-4 illustrate the swept sine output signal to the amplifier, the time series response of the accelerometer and the power spectra calculated from the accelerometer signal. The resonant frequency was found to be 513 Hz.

### EXAMPLE 2

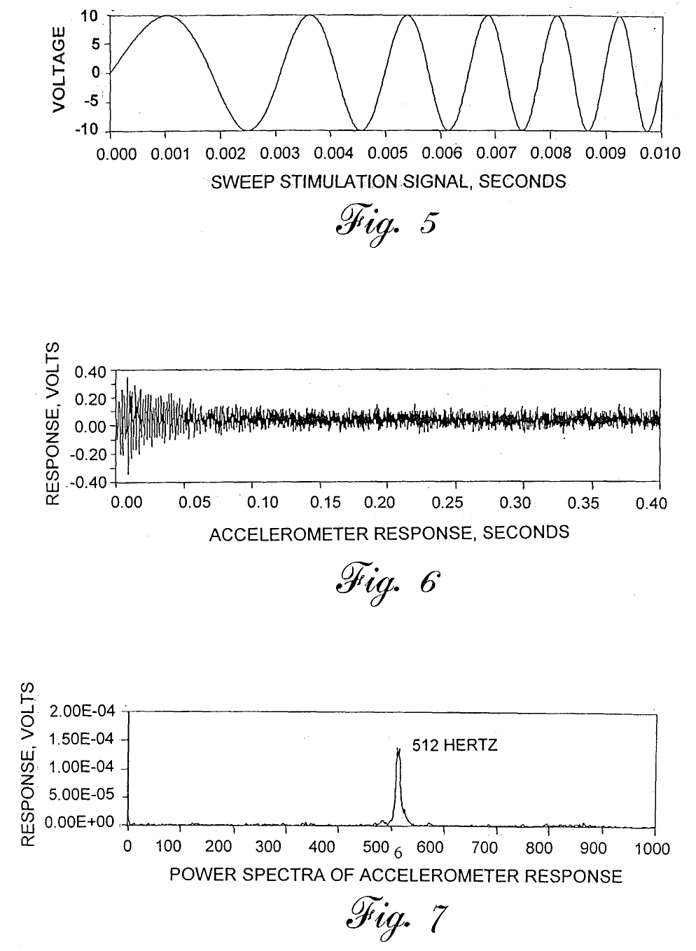

As seen in FIGS. 5-7, the Douglas-fir log of the previous example was again used but the time of the swept signal was reduced to 0.01 second. Excellent results were obtained with the shorter sweep time, the resonant frequency of 512 Hz comparing closely with that determined by the longer pulse time.

### EXAMPLE 3

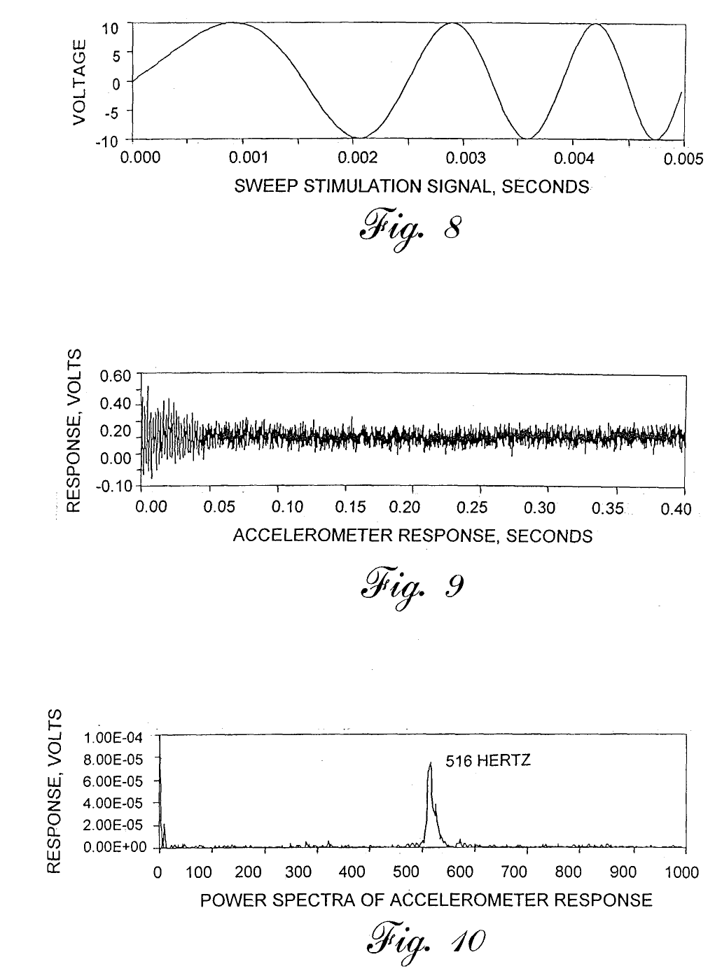

In similar fashion to Example 2 and as seen in FIGS. 8-10, the time for the swept frequency pulse was again shortened to 0.005 seconds. Once again a sharp resonance peak was seen at 516 Hz, almost identical to the responses seen with the 0.2 or 0.01 second pulse durations. The advantage of being able to use these shorter sweep times cannot be overemphasized, especially in fast moving the environment of a mill situation. It opens the possibility of making the measurement without stopping movement of the log being measured.

### EXAMPLE 4

The above apparatus was similarly used in the laboratory to determine the resonant frequency of a western hemlock log which was 11½ ft (˜3.5 m) long having a butt end diameter averaging about 18 in (0.46 m). The distance between the speaker and the log was approximately 5 ft (1.5 m) and the sweep range was 400-900 Hz in 0.2 seconds. Repeated tests with different speaker power levels and accelerometer positions at both log ends and against the side of the log gave identical results of a resonant frequency of 727 Hz.

### EXAMPLE 5

The log of Example 4 was tested again to determine the relationship between frequency sweep, sweep period, and response power. In all cases the high end of the frequency sweep was 1000 Hz. For these tests the accelerometer was in contact at the far end of the log. Results are seen in the following table.

| Low End of | Sweep period, | Resonant | Relative |
|---|---|---|---|
| Sweep, Hz. | seconds | Frequency, Hz. | Response Power |
| 400 | 0.2 | 750 | 275 |
| 500 | 0.2 | 750 | 650 |
| 400 | 0.25 | 740 | 325 |
| 500 | 0.25 | 748 | 700 |
| 400 | 0.3 | 750 | 800 |
| 500 | 0.3 | 750 | 1000 |

It is immediately evident that a dramatic increase in the detected output signal was obtained simply by raising the sweep range 100 Hz at the lower end so that it spanned about ±250 Hz either side of the expected resonance point. This was more evident at the shorter sweep times where the increase was 236% at 0.2 seconds but still 125% at 0.3 second sweep time. The greater output signal is of very significant importance when the equipment is operating in the intense low frequency noise environment in a mill.

It will be evident to those skilled in the Art that many variations not exemplified herein could be made without departing from the spirit of the invention. It is the inventor's intent that these variations should be covered if encompassed within the following claims.

1. A method of determining a physical property of a wood member which comprises:
determining the length of the wood member;
relating the length of the wood member to the range within which the resonant frequency of the member is expected to fall;
providing an swept audio frequency energy impulse directed at the wood member, the frequency sweep falling within a range of about 100-1000 Hz within a period less than about 1 second;
adjusting the frequency sweep range dependent on the member length, the sweep range encompassing at least the range within which the resonant frequency of the member is expected to fall;
sensing the response to the audio energy impulse within the wood member so as to determine the actual resonant frequency of the member; and
relating the resonant frequency to the physical property being measured,
whereby by adjusting the sweep range to a relatively narrow band encompassing the expected resonant frequency range of the wood member, the energy introduced into the wood member is maximized and the resolution of the sensed response is increased.

2. The method of claim 1 in which the frequency is swept about ±300 Hz either side of the midpoint of the anticipated resonant frequency range of the wood member.

3. The method of claim 1 in which the frequency is swept at least about ±100 Hz either side of the midpoint of the anticipated resonant frequency range of the wood member

4. The method of claim 1 in which sweep time is no longer than about 0.2 seconds.

5. The method of claim 4 in which the sweep time is no longer than about 0.1 second.

6. The method of claim 1 in which the wood member is a log.

7. The method of claim 1 in which the property being determined is modulus of elasticity.

8. The method of claim 7 in which the modulus of elasticity is used in a cutting optimizer program to determine optimum breakdown of a saw log.

9. The method of claim 1 in which the sensed response is measured by an accelerometer in contact with the wood member.

10. The method of claim 1 in which the sensed response is measured by a laser Doppler vibrometer.
